(19) United States
(12) Patent Application Publication
(10) Pub. No.: US 2010/0223592 A1
(43) Pub. Date: Sep. 2, 2010

(54) CODE COMPONENT LEVEL INTELLECTUAL PROPERTY REMEDIATION

(75) Inventors: HEATHER MARIA HINTON, Austin, TX (US); Jeffrey R. Dean, Austin, TX (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/395,964

(22) Filed: Mar. 2, 2009

(51) Int. Cl. G06F 9/44

(52) U.S. Cl. 717/105

(57) ABSTRACT

A method, system, and computer usable program product for code component level IP remediation are provided in the illustrative embodiments. An actionable instance of the third-party's intellectual property is identified in a component of the product. A component model of the product is constructed. The actionable instance of the third-party's intellectual property is associated with a component in the component model. A graphical representation of the component model is created. Information about a type of license associated with the actionable instance is added to the graphical representation of the component. The graphical representation is published. The actionable instance may be identified based on the type of the license associated with the third-party's intellectual property, a context of the inclusion, or both. A remediation action is identified for the actionable instance. Information corresponding to the remediation action is added to the component using visual highlights in the graphical representation.

### RELATED APPLICATION

The present invention is related to similar subject matter of co-pending and commonly assigned U.S. patent application Ser. No. ______ (Attorney Docket No. AUS920080784US1) entitled “ASSESSING INTELLECTUAL PROPERTY INCORPORATED IN SOFTWARE PRODUCTS,” filed on ______, 2008, which is hereby incorporated by reference.

### BACKGROUND OF THE INVENTION

1. Field of the Invention

The present invention relates generally to an improved data processing system, and in particular, to a computer implemented method for analyzing and modifying a software product. Still more particularly, the present invention relates to a computer implemented method, system, and computer usable program code for code component level intellectual property (IP) remediation of a third-party's IP (third-party IP) that may be incorporated in a software product.

2. Description of the Related Art

A software product is a collection of various types of code, text, and data. For example, a software product may include a computer file that may include instructions to be executed by a computer, the instructions being in a high level programming language, object code, or machine language. The software product may include data, such as in a database, for performing a desired function. The software product may further include a file that includes text or instructions, such as license information, for use during the code execution.

A user may analyze a software product for a variety of reasons. For example, a user may analyze a software product for identifying or correcting errors, for inclusion or removal of testing information, for inclusion or exclusion of authorized or unauthorized information, and many other reasons. Analyzing a software product is analyzing any or all parts of the software product. For example analyzing a software product may include analyzing only the code, a portion of the code and a portion of the text files, or some combination of the code, text, and data associated with the software product.

Software products often include portions that may be protected by intellectual property rights. The software manufacturer, the customer, or a third-party may own these IP rights. As an example, the third-party may be another manufacturer or an open-source code provider.

A software product may include many components. A code component is a type of component and includes a portion of a code that is used in the software product. For example, the code for a set of classes in the object-oriented code of the software product may be a code component. A set of classes is one or more classes. As another example, a particular code file, data file, or text file may be a code component of the software product.

A module is a component of the software product that is so encapsulated as to be capable of addition to, removal from, or other manipulation in the software product as a part of the software product configuration. For example, code of a software product that provides interconnectivity with a specific type of enterprise system from the software product may be a module of the software product.

A functionality of a software product is a set of functions, operations, or features the software product is capable of performing. A set of functions, operations, or features is one or more functions, operations, or features. Certain functionality of a software product may also be encapsulated as a component so that the component may be added to, removed from, or other manipulated in the software product as a part of the software product configuration. A module may include a set of functionality. A set of functionality is one or more functionality. A functionality may span a set of modules, to with, a set of modules may collectively provide a functionality of a software product.

### SUMMARY OF THE INVENTION

The illustrative embodiments provide a method, system, and computer usable program product for code component level IP remediation of a third-party IP that may be incorporated in a software product. An actionable instance of the third-party's intellectual property is identified in a component of the product. A component model of the product is constructed. The actionable instance of the third-party's intellectual property is associated with a component in the component model. A graphical representation of the component model is created. Information about a type of license associated with the actionable instance is added to the graphical representation of the component. The graphical representation is published.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a level of graphical representation of a software product in accordance with an illustrative embodiment;

FIG. 4 depicts a block diagram of a process of generating a component model in accordance with an illustrative embodiment;

FIG. 5 depicts a block diagram of another level of graphical representation of a software product in accordance with an illustrative embodiment;

FIG. 6 depicts a block diagram of another level of graphical representation of a software product in accordance with an illustrative embodiment;

FIG. 7 depicts a block diagram of a process of generating a component model showing instances of third-party IP inclusion in accordance with an illustrative embodiment;

FIG. 8 depicts a block diagram of a graphical representation of code component level third-party IP inclusion in accordance with an illustrative embodiment;

FIG. 9 depicts a block diagram of a graphical representation of code component level third-party IP license types in accordance with an illustrative embodiment;

FIG. 10 depicts a block diagram of a graphical representation of code component level third-party IP remediation in accordance with an illustrative embodiment;

FIG. 11 depicts a block diagram of a graphical representation of the results of code component level third-party IP remediation in accordance with an illustrative embodiment;

FIG. 12 depicts a flowchart of a process of graphically representing code component level third-party IP remediation in accordance with an illustrative embodiment;

FIG. 13 depicts a flowchart of a process of modifying a graphical representation of code component level third-party IP remediation in accordance with an illustrative embodiment; and

FIG. 14 depicts a flowchart of a process of interacting with a remediation process for code component level third-party IP remediation in accordance with an illustrative embodiment.

### DETAILED DESCRIPTION OF THE PREFERRED EMBODIMENT

A portion of a software product may be protected by one or more intellectual property (IP) assets such as patent, trademark, or copyright. The illustrative embodiments recognize that before such a software product can be released for use, the manufacturer may want to ensure that any included IP assets are suitably licensed. Furthermore, the illustrative embodiments recognize that the manufacturer may also want to know whether any licensed IP asset included in the software product causes unintended conflict, lapse, or release of other IP rights associated with the same or different software product.

As an example, normally, a software manufacturer desires to keep the source code of their software product a secret. However, using segments of open-source software code under certain open-source licensing agreements within the software product may subject the otherwise proprietary code of a software product to full disclosure.

Currently, tedious review of the code is performed to reveal the above described IP licensing issues and other similar IP asset related problems. The illustrative embodiments recognize that such a method of assessing and remedying third-party IP in a software product is time consuming, error prone, and labor intensive.

The illustrative embodiments further recognize that currently, even when third-party IP is identified in a software product, further work is needed to act on such inclusions on a case by case basis. For example, currently, if a user, who may be reviewing the code, finds an open-source licensed code segment in the software product, the user may be left to his or her own process to determine what to do with the finding. One user may escalate the issue to a supervisor, whereas another user may ignore the inclusion. Yet another user may rework the code to isolate or eliminate the inclusion. The illustrative embodiments recognize that current method of remedying third-party IP inclusions in a software product may lead to inconsistent and even undesirable actions by the users.

Furthermore, the illustrative embodiments recognize that software products often include numerous files, components, and alternative configurations. As an example, a commonly used software product, such as a spreadsheet application, may include millions of lines of code contained in hundreds or thousands of files, and spread across dozens of modules and functionalities. Some software products, such as an operating system, may be orders of magnitude larger in size and complexity. The present methods of identifying and remedying third-party IP related issues across such vast software products lead to a number of additional problems.

For example, while one user, a software engineer, may appreciate the heightened risk of including a third-party IP in a particular component due to the criticality of the component in the software product, another user, such as an IP attorney, may not. Conversely, while a software engineer may find ignoring such an inclusion an acceptable option for technical reasons, an IP attorney may find the inclusion unacceptable due to the legal ramifications.

The illustrative embodiments recognize that different users may evaluate an included third-party IP from different perspectives, not always having a uniform understanding how that IP fits in the software product. Additionally, different users have different appreciation of the risks associated with third-party IP inclusions because of these differing perspectives. For example, a graphical view of an object model may give a technical user sufficient warning of a risk from a particular inclusion but the same view may impart no information to a non-technical user to appreciate the same risk.

To address these and other related problems in present methods of managing third-party IP inclusions in software products, the illustrative embodiments provide a method, computer usable program product, and data processing system for code component level IP remediation of a third-party IP that may be incorporated in a software product. Using the illustrative embodiments, a software manufacturer can implement automated analysis of software products for identifying third-party IP inclusions therein. Using the illustrative embodiments, the manufacturer can further implement presentation methods that facilitate an improved understanding of the nature, location, consequences, and remediation of the third-party IP inclusions.

Remedial action, or remediation, is an action that manipulates the included third-party IP. Such manipulation may be within the software product, such as by code change, or outside of the software product, such as by someone engaging in a license negotiation. The end-result of the manipulation is to make the inclusion acceptable to the software manufacturer when the software product is released for its intended use. A remediation report is a report that identifies third-party IP inclusions and suggests a remedial action with respect to the third-party IP inclusions.

The examples in this disclosure are used only for the clarity of the description and are not limiting on the illustrative embodiments. Additional operations, actions, tasks, activities, and manipulations will be conceivable from this disclosure and the same are contemplated within the scope of the illustrative embodiments.

The illustrative embodiments are described using code, files, and databases only as examples and are not limiting on the illustrative embodiments. The illustrative embodiments may be implemented with respect to any type of data and any type of IP that can be used in a product. Furthermore, the illustrative embodiments are described in some instances using particular data processing environments only as an example for the clarity of the description. The illustrative embodiments may be used in conjunction with other comparable or similarly purposed systems, applications, or architectures.

Furthermore, the illustrative embodiments are described using software products only as examples. The illustrative embodiments are similarly applicable to firmware products and hardware products that may include third-party IP.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

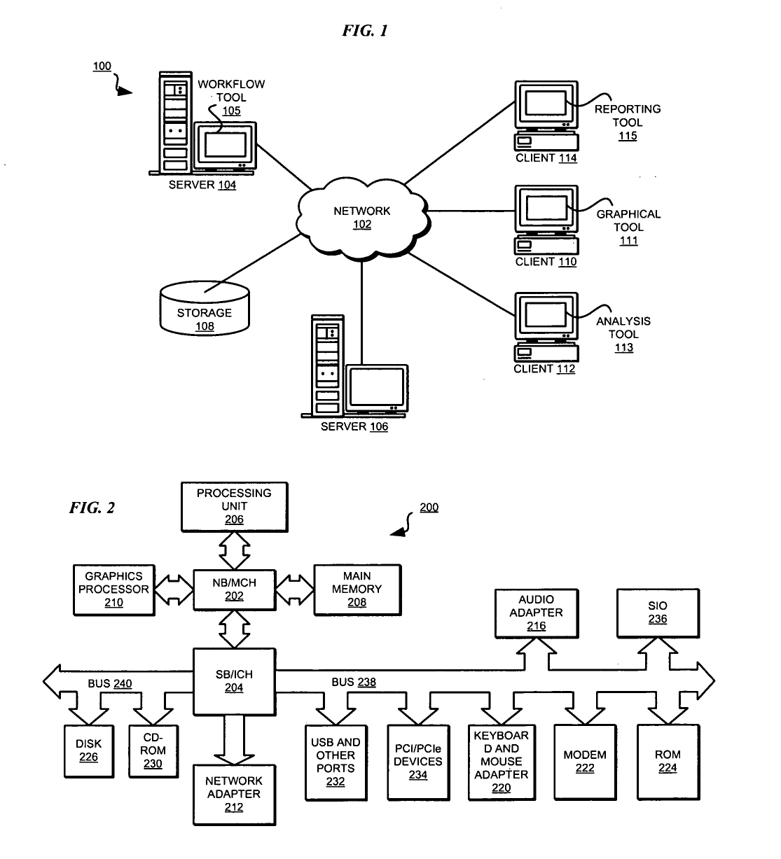

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may have software applications or software tools executing thereon. For example, server 104 may include workflow tool 105 executing thereon. Workflow tool 105 may be a software application that facilitates planning and executing tasks. Client 110 may include graphical tool 111. Graphical tool 111 may be a software application capable of manipulating data, rendering data in graphical form, accepting user inputs, data communications, outputting data to users and systems, or any combination thereof.

Client 112 may include analysis tool 113. As an example, analysis tool 113 may analyze code or other information associated with a software product for identifying third-party IP inclusions. Analysis tools are also known as code scanning tools.

Client 114 may include reporting tool 115 executing thereon. Reporting tool 115 may, for example, generate remediation reports using the analysis performed by analysis tool 113.

Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

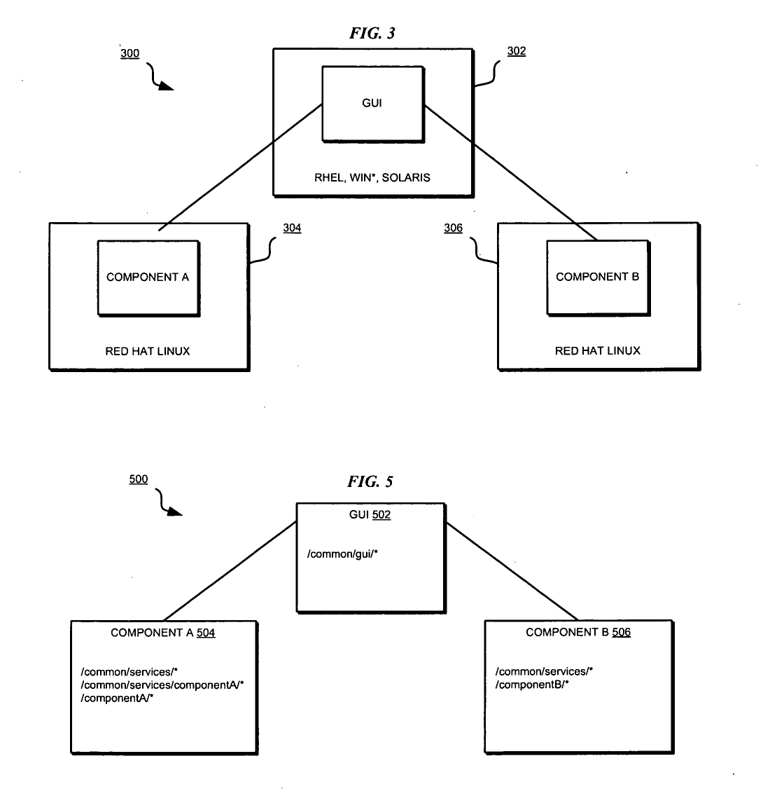

With reference to FIG. 3, this figure depicts a block diagram of a level of graphical representation of a software product in accordance with an illustrative embodiment. Graph 300 may be constructed, manipulated, or displayed, using graphical tool 111 in FIG. 1.

For example, graph 300 may be a high-level deployment diagram that may be produced by a Unified Modeling Language (UML) design tool, or created using a build tree or a make file. In other words, graph 300 may represent a component model, which is a structured list of components of a software product. The component model of graph 300 may be constructed using the information in code, a model, or a configuration file associated with the software product.

In this figure, graph 300 depicts a graphical representation of several example functionalities of an example software product. Blocks 302, 304, and 306, each represent certain functionality and the identifiers of one or more types of code for that functionality at a high level. As an example, block 302 represents a graphical user interface (GUI) functionality of the software product that may include code for multiple operating systems. For example, the GUI functionality of the software product may include code for operation on Red Hat Enterprise Linux®, Windows, and Solaris®. (Red Hat, Red Hat Enterprise Linux, RHEL, and Red Hat Linux are trademarks of Red Hat, Inc. in the United States and other countries. Solaris is a trademark of Sun Microsystems, Inc. in the United States and other countries).

Block 304 may represent a component, “component A,” of the software product, with the code for component A being available for Red Hat Linux. Block 306 may represent another component, “component B,” of the software product, with the code for component B being available for Red Hat Linux.

Graph 300 further depicts one or more relationships among the various functionalities, such as between the functionalities of blocks 302, 304, and 306. For example, the GUI functionality depicted as block 302 may include the functionality of component A of block 304 and component B of block 306 as implemented on Red Hat Linux.

With reference to FIG. 4, this figure depicts a block diagram of a process of generating a component model in accordance with an illustrative embodiment. Code scan report 402 may be generated by code scanning tools such as analysis tool 113 in FIG. 1.

A code scanning tool may generate code scan report 402 by scanning all or a portion of the code for a software product. Code scan report 402 may be formatted in any format suitable for a particular implementation. For example, particular implementations of the illustrative embodiments may format code scan report 402 in extensible markup language (XML), comma separated value file (CSV), or other suitable formats, such as a spreadsheet or a database table.

The illustrative embodiment may combine any number of additional information inputs with code scan report 402. As an example, FIG. 4 depicts combining knowledge-bases 404 and 406 with code scan report 402. Knowledge-base 404, for example, may be a manifest of components in a particular build of the software product. Knowledge-base 404 may be implemented in any format suitable for a particular implementation. In one embodiment, knowledge-base 404 may be a configuration file. In another embodiment, knowledge-base 404 may be a set of records in a database.

Knowledge-base 406, as another example, may be a source of information about dependencies among the various components in a particular configuration of the software product. For example, dependencies identified by knowledge-base 406 may be the dependencies in the configuration analyzed by the code scanning tool to generate code scan report 402.

The illustrative embodiment parses code scan report 402 and one or more knowledge-base input using parser 408. Parser 408 may analyze the various inputs and correlate the information contained therein. For example, parser 408 may receive source code structure information 410 from parsing code scan report 402. Parser 408 may receive a list of build components 412 from parsing information from knowledge-base 404. Build components 412 may include any type of components, modules, or functionalities within the scope of the illustrative embodiments. Parser 408 may further receive information about dependencies 414 between the various components, modules, or functionalities.

Code scan report 402 and knowledge-bases 404 and 406 are depicted only as examples and are not limiting on the illustrative embodiments. Parser 408 may receive inputs from any number of knowledge-bases within the scope of the illustrative embodiments. Other knowledge-bases that may be used for providing inputs to parser 408 will become apparent from this disclosure.

Parser 408 generates component model 416. Component model 416 may be a high-level component model, such as the high-level component model depicted in graph 300 in FIG. 3. A particular implementation may construct, orient, display, configure, render, or present component model 416 in any manner suitable for the implementation. For example, one embodiment may present component model 416 on a physical display unit of a data processing system accessible to a user. Another embodiment may present component model 416 as a hard-copy printout on a printing device. One embodiment may render component model 416 as a hierarchy in a tree form. Another embodiment may render component model 416 in an indented list form within the scope of the illustrative embodiments.

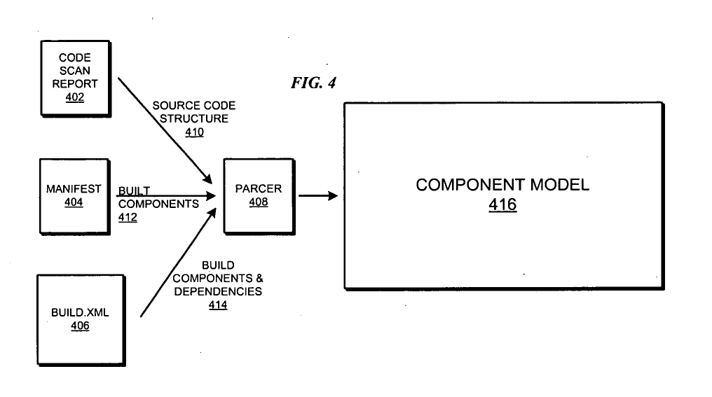

With reference to FIG. 5, this figure depicts a block diagram of another level of graphical representation of a software product in accordance with an illustrative embodiment. Graph 500 may be constructed, manipulated, or displayed using graphical tool 111 in FIG. 1, which implements parser 408 of FIG. 4.

Graph 500 may add a level of details to a high-level deployment diagram, such as to graph 300 in FIG. 3. In other words, graph 500 may add code component level information to a component model produced using the process of FIG. 4.

In this figure, graph 500 is a graphical representation of code component level details of several example functionalities of the example software product used in FIG. 3. Block 502 represents a GUI functionality of the software product that may include code for multiple operating systems. Block 504 may represent a component, “component A,” of the software product, with the code for component A being available for Red Hat Linux. Block 506 may represent another component, “component B,” of the software product, with the code for component B being available for Red Hat Linux.

In accordance with an illustrative embodiment, blocks 502, 504, and 506 in this figure also list code components that are included in the components represented by those blocks. For example, code for all classes located in “/common/gui” directory is shown to be compiled for building the GUI component of the software product. Similarly, code for all classes stored in “/common/services”, “/common/services/component A”, and “/componentA” directories is shown to be compiled for component A of the software product. The various code components of component B of block 506 are similarly identified.

The level of detail in blocks 502-506 in FIG. 5 is depicted only as an example. In accordance with the illustrative embodiments, a component diagram of graph 500 may include various levels of details. Further, in accordance with the illustrative embodiments, the various levels of details may be revealed in graph 500 simultaneously, or progressively. For example, in one embodiment, the illustrative embodiments may first display graph 300 in FIG. 3, receive an input from the user to add a level of detail, and then display graph 500 including the code component level detail.

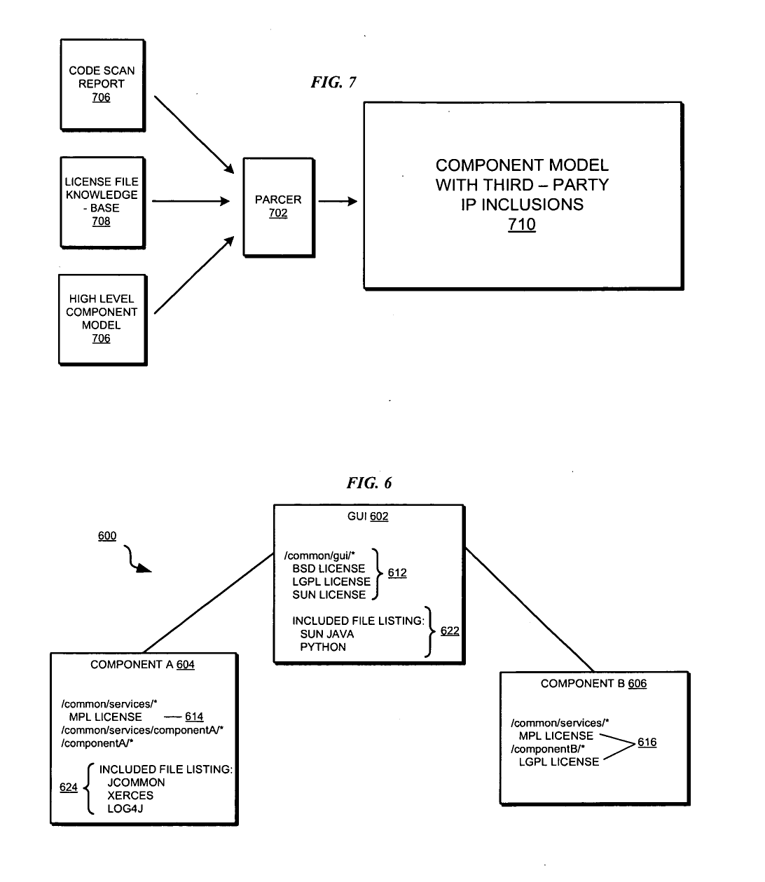

In another embodiment, the illustrative embodiments may be implemented such that the various illustrative embodiments form one or more iterations of an iterative analytical cycle. For example, as described with respect to FIG. 7, component model 416 in FIG. 4, represented as graph 300 in FIG. 3 may result from a first iteration of software product analysis. In a subsequent iteration, an illustrative embodiment may use component model 416 of FIG. 4 from the previous iteration as one of the inputs. Such subsequent iteration may produce a more detailed component model, one that includes code component level detail, such as graph 500 in FIG. 5. Additional levels of details may be added to the graphical representation of the component model presented in this manner. FIG. 6 depicts the addition of another level of detail to graph 500 of FIG. 5.

With reference to FIG. 6, this figure depicts a block diagram of another level of graphical representation of a software product in accordance with an illustrative embodiment. Graph 600 may be constructed, manipulated, or displayed using graphical tool 111 in FIG. 1, which implements parser 408 of FIG. 4. Graph 600 is similar to graph 500 in FIG. 5, and adds another level of code component details to graph 500 in FIG. 5. Blocks 602, 604, and 606 correspond to blocks 502, 504, and 506 respectively in FIG. 5.

In accordance with an illustrative embodiment, blocks 602, 604, and 606 also list license types associated with the code components that are included in the components represented by those blocks. For example, code for all classes located in “/common/gui” directory is shown to be compiled for building the GUI component of the software product in block 602. In addition, block 602 includes license information 612 associated with those code components. License information 612 informs a user that the GUI component of the software product includes code portions that have associated with them three different types of licenses. Furthermore, license information 612 informs that the licenses include one or more third party licenses, such as Berkeley Software Distribution (BSD) license—a type of open source license, GNU Lesser General Public License (LGPL)—another type of open source license, and Sun® license from a software manufacturer (Sun is a trademark of Sun Microsystems, Inc. in the United States and other countries).

Similarly, code for all classes stored in “/common/services”, “/common/services/component A”, and “/component A” directories is shown to be compiled for component A of the software product in block 604. License information 614 informs a user that component A of the software product includes one or more code portion that have associated with it a Mozilla Public License (MPL)—a type of open source license.

License information 616 informs the user that code components or portions thereof in “/common/services” directory have MPL licenses associated therewith. License information 616 also informs that code components or portions thereof in “/componentB” directory have LGPL licenses associated therewith.

Additional details may be included with code component level information. For example, file list 622 in block 602 informs a user of the additional files, code components, or other components that may be associated with the GUI component's code components in /common/gui directory. Similarly, file list 624 in block 604 informs a user of the additional files, code components, or other components that may be associated with the component A's code components in any or all of the listed directories. File lists 622 and 624 may also indicate that the illustrative embodiments have analyzed those additional code components or files for third-party IP inclusions.

With reference to FIG. 7, this figure depicts a block diagram of a process of generating a component model showing instances of third-party IP inclusion in accordance with an illustrative embodiment. Parser 702 may be implemented using parser 408 in FIG. 4.

The process in FIG. 4 accepts certain inputs from certain knowledge-bases and produced a component model. FIGS. 5 and 6 depict component models that include additional levels of third-party IP inclusion details. The process of this figure depicts a way of generating the component models of FIGS. 5-6 and other similarly detailed component models.

Parser 702 may accept any number of inputs from any number of knowledge-bases, or other input sources. The process of this figure may be executed as a separate process to generate a component model with specific level of third-party IP details. The process of this figure can also be executed as a subsequent iteration of the process of FIG. 4 by replacing the inputs in the manner of the example shown. The process of this figure may generate the component model of FIGS. 5 and 6, or other similarly detailed models, in an automatic manner of progressively increasing details or upon the occurrence of certain events, such as upon receiving a user input.

Parser 702 accepts as one input, high level component model 704, such as component model 416 in FIG. 4. Code scan report 706 may be similar to code scan report 402 in FIG. 4, and may form a second input to parser 702.

Knowledge-base 708 may be a repository containing information about the various types of third party IP licenses that may be found in a software product. For example, knowledge-base 708 may be a license file knowledge-base.

The illustrative embodiment may combine any number of additional information inputs as may be suitable for a particular implementation. For example, another knowledge-base may be used that may include information about certain known authors who have produced IP that is problematic in some respect. Such a knowledge-base may provide information that may be helpful in identifying third-party IP that has to be remedied to remove the problematic inclusion. As an example, an author may have produced a piece of code that was included based on a license that has since been repudiated. Another knowledge-base may include information about repudiated licenses, and may be used to identify instances of repudiated licenses to remediation.

As another example, an author may be an employee who has refused to assign rights to the IP to the employer. A knowledge-base may include information about the various products, code, files, and other work products that the programmer may have worked on, and identify inclusions there from for remediation. As another example, another knowledge-base may include information that may be used to determine percentage contributions of different programmers to an overall application. Such a knowledge-base may be used to determine if appropriate compensation or reward for their IP contribution has been paid prior to the inclusion of their respective IP.

These examples of the various knowledge-bases are used only for describing some of the possibilities with the illustrative embodiments. These example knowledge-bases are not intended to be limiting on the illustrative embodiments. Many other knowledge-bases with information about many contexts of the third-party IP inclusion will be apparent from this disclosure and the same are contemplated within the scope of the illustrative embodiments.

Parser 702 may parse the information available from the various inputs. Parser 702 may analyze the various inputs and correlate the information contained therein. For example, parser 702 may receive source code structure information from parsing code scan report 706. Parser 702 may receive a list of components and their inter-dependencies from parsing information from high-level component model 704. Parser 702 may further receive information about identifiers that identify an included third-party IP.

Parser 702 may execute certain rules to generate report 710. Report 710 may be a component model with a level of detail about the third-party IP inclusions in the analyzed software product. In one embodiment, report 710 may provide information similar to that in graph 500 in FIG. 5. In another embodiment, report 710 may provide information similar to that in graph 600 in FIG. 6.

The rules executed by parser 702 may be configured in parser 702 or may be provided from a rules repository as input from another knowledge-base. A rule used by parser 702 to generate report 710 may determine whether a third-party IP inclusion in the analyzed product is actionable or not-actionable. A rule may determine whether a remediation action is necessary, optional, or not needed for specific instances of third-party IP inclusions. A rule may also determine if the remediation action or another action is to be performed automatically when an instance of third-party IP inclusion meets certain conditions.

A rule may also determine a way of rendering a particular detailed information in report 710. For example, a rule may cause the parser to color a block or a line in report 710 a certain color to indicate actionable third-party IP inclusion.

A rule may trigger parser 702 to perform further iterations of analysis. A rule may cause parser 702 to wait for an event before populating report 710 with additional levels of detailed information about third-party IP inclusions, product analysis, or both.

The rules described above are described only as examples for the clarity of the illustrative embodiments. These rules are not intended to be limiting on the illustrative embodiments. Many other rules will become apparent from this disclosure and such rules are contemplated within the scope of the illustrative embodiments.

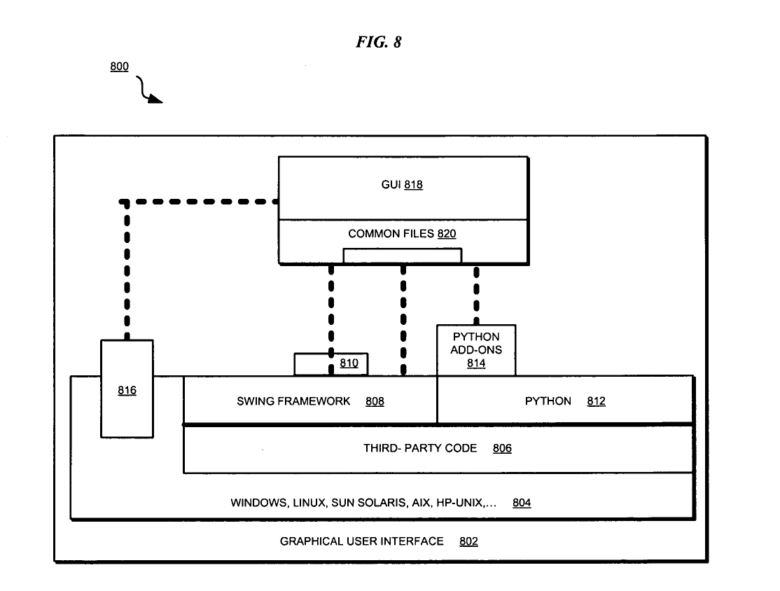

Graphs 300, 500 and 600 in FIGS. 3, 5, and 6 are only example graphical depictions resulting from a combination of the processes of FIGS. 4 and 7. These graphs, the manner of graphical depictions therein, the manner of depicting levels of detailed information therein are not limiting on the illustrative embodiments. The illustrative embodiments can be configures to produce graphical depictions in component model 416 and report 710 in other forms within the scope of the illustrative embodiments. Some alternate or additional graphical depictions that may be generated from the illustrative embodiments are described with respect to FIGS. 8-11.

With reference to FIG. 8, this figure depicts a block diagram of a graphical representation of code component level third-party IP inclusion in accordance with an illustrative embodiment. Graphical representation 800 may be generated by a parser, such as parser 408 in FIG. 4 or parser 702 in FIG. 7, using a combination of the processes of FIGS. 4 and 7.

Graphical representation 800 may be generated, such as in report 710, in addition to or instead of graphs, such as graphs 500 or 600 in FIG. 5 or 6 respectively. In the example depicted in FIG. 8, graphical representation 800 depicts code component level third-party IP inclusions in an example GUI component of an example software product. For example, graphical representation 800 may be an alternate or additional depiction of the contents of block 602 in FIG. 6.

Graphical representation 800 depicts some of the modules that may be included in GUI component 802 of a software product. Modules in graphical representation 800 are depicted as stacked, interconnected, fully or partially embedded, or otherwise related to one another to facilitate a graphical view of the construct of the component. Such a depiction may be useful for all types of users to appreciate the nature and criticality of third-party IP inclusions in the various modules. Such a depiction may be particularly helpful for non-technical persons who may otherwise not fully comprehend the larger consequences of third-party IP inclusion in one module due to modular interdependencies.

GUI component 802 is shown to include module 804, which may provide code for operating system level support of other modules for various operating systems. Within module 804 may be module 806, which may be a particular piece of code including a particular type of third-party IP. Module 808 may be included in or depend on module 806. For example, module 808 may be Swing framework, which is a widget toolkit for Java® and is a part of Java Foundation Classes® (JFC) (Java, Java Foundation Classes, and JFC are trademarks of Sun Microsystems, Inc. in the United States and other countries). Thus, graphical representation 800 shows in one example way that module 808 may include code protected by a third-party IP.

Module 810 may be an extension, a connector code, a toolkit, or other code that may depend on or relate to module 808. Module 810 may include a type of third-party IP.

As another example, module 812 may be included in or depend on module 806. For example, module 812 may be implemented in Python, which is a programming language. Code written in certain programming languages often utilize programming toolkits that are proprietary or otherwise protected by third-party IP. For example, module 814 may be a Python add-on toolkit from a third-party software provider. A software manufacturer may have a policy or other justification to scan the code written in a particular language more closely than others for third-party IP inclusions. Thus, graphical representation 800 shows in another example way that module 812 may include code protected by a third-party IP.

Module 816 may be a collection of operating system kernel fixes, drivers, driver enhancements, or other operating system related code components. As an example, occasionally, a driver or a driver enhancement may be provided by a software vendor different from the vendor of the operating system. For this and other similar reasons, such modules may have to be inspected and remedied for third-party IP inclusion differently from the operating system code components. Thus, the illustrative embodiments may identify code components such as module 816 separate from operating system code components.

Module 818 may be the software manufacturer's own GUI code used in building GUI component 802. Module 818 may utilize module 820, such as by including some of the contents of module 820 in constructing module 818. Module 820 may include files, code, data, tools, or other proprietary materials that the software manufacturer may regard as their own.

Module 818 may utilize operating system features and functions by using module 816. Module 820 may provide certain functionalities by communicating with other modules, such as modules 808, 810, and 814.

Thus, the illustrative embodiments may present graphical representation 800 as a way to inform a user about the presence and interactions of the various modules, code segments, code components, functions, and features of a component of a software product. The illustrative embodiments thus provide a user with visual clues of what third-party IP may be included in a particular configuration of the software product.

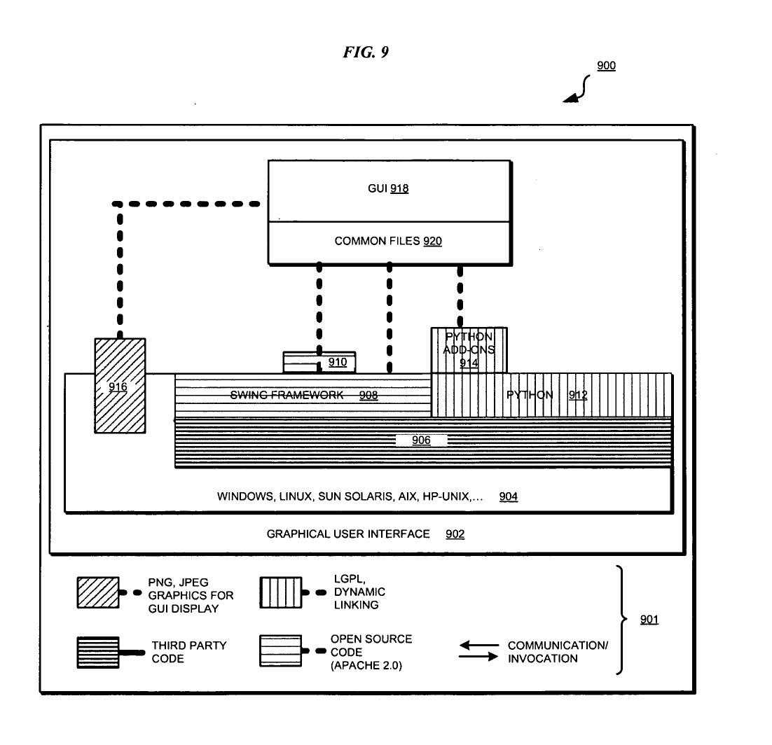

A user may be able to determine a type of license associated with a particular third-party IP inclusion based of graphical representation 800. Another user may find it useful to have the illustrative embodiments distinguish the various types of licenses associated with the various third-party IP inclusions. FIG. 9 depicts an example way of making such distinctions.

With reference to FIG. 9, this figure depicts a block diagram of a graphical representation of code component level third-party IP license types in accordance with an illustrative embodiment. Graphical representation 900 may be generated by a parser, such as parser 408 in FIG. 4 or parser 702 in FIG. 7, using a combination of the processes of FIGS. 4 and 7.

Graphical representation 900 may be generated, such as in report 710, in addition to or instead of graphs, such as graphs 500 or 600 in FIG. 5 or 6 respectively. In the example depicted in FIG. 9, graphical representation 900 depicts code component level third-party IP inclusions and license types associated therewith.

Furthermore, graphical representation 900 may be generated directly or as an enhancement to graphical representation 800 in FIG. 8. Graphical representation 900 adds license types as a level of detail to graphical representation 800 in FIG. 8.

Legend 901 correlates a graphical marking with a type of license. The specific graphical markings depicted in graphical representation 900 are only examples and are not limiting on the illustrative embodiments. Any graphical marking suitable for a particular implementation may be used within the scope of the illustrative embodiments. For example, an implementation may depict the various license types by using different colors in a color rendition of graphical representation 900.

Graphical representation 900 depicts only some of the license types associated with only some of the modules that may be included in GUI component 902 of the example software product. For example, module 906 that may include third-party code is highlighted using a distinct graphical marking to depict a particular characteristic of the license associated with that code in module 906. For example, the third-party code in module 906 may be proprietary to a specific third-party and may have been suitably licensed from that third-party.

As another example, modules 908 and 910 may include open-source code with a type of public license associated with that open-source code. To depict and distinguish the license associated with modules 908 and 910 from the license associated with module 906, graphical representation 900 highlights modules 908 and 910 using another distinct graphical marking.

Modules 912 and 914 may have yet another type of license associated with them. Graphical representation 900 highlights modules 912 and 914 using a third distinct graphical marking to depict the distinction between the various license types. Graphical representation 900 of the illustrative embodiments highlights module 916 using a fourth distinct graphical marking for a similar purpose.

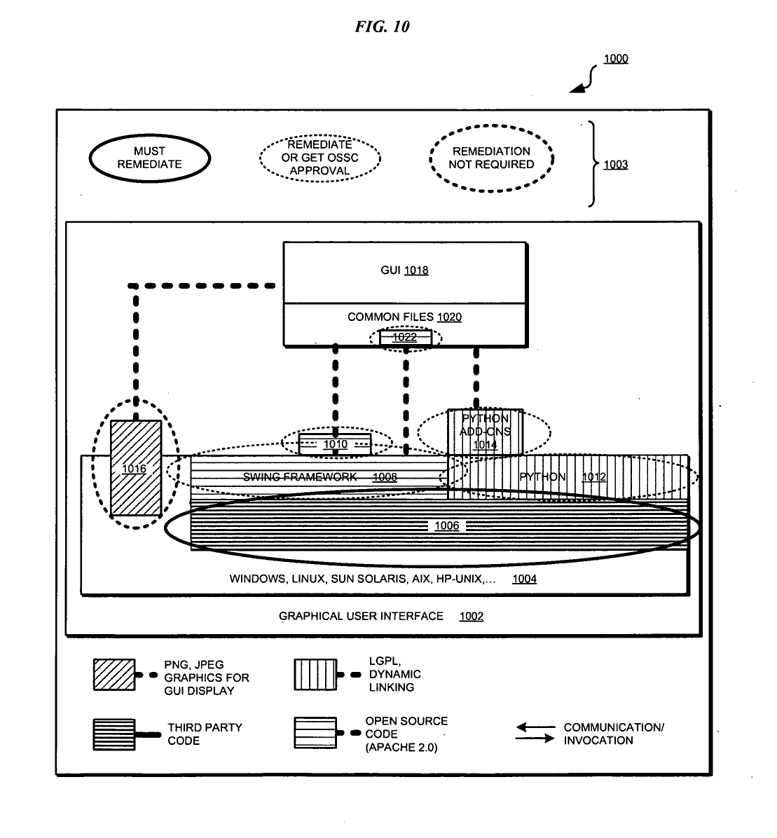

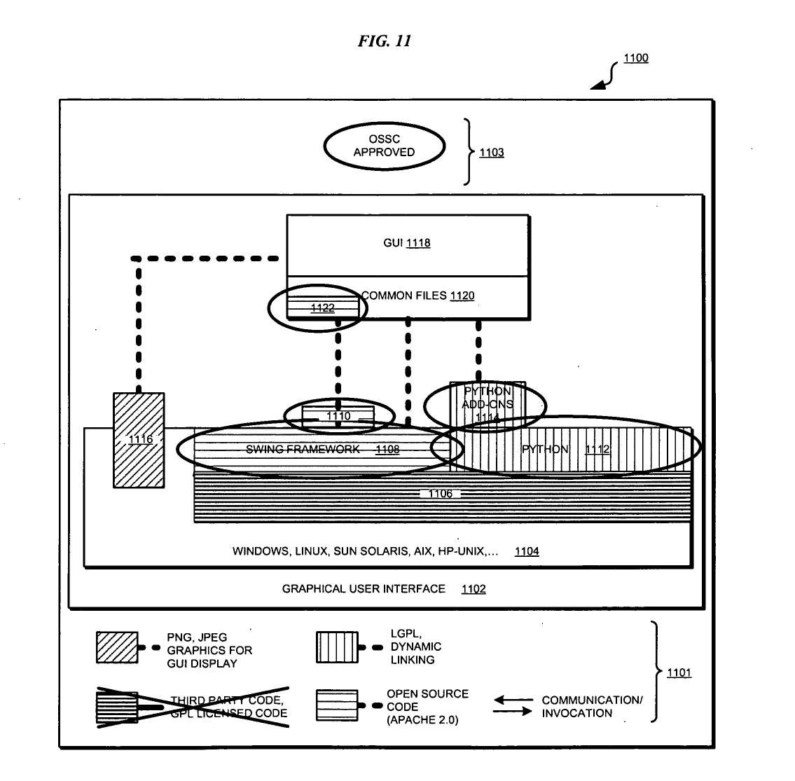

A user may be able to determine a course of action to remedy a third-party IP inclusion based of graphical representation 900. Another user may find it useful to have the illustrative embodiments recommend remediation actions for certain third-party IP inclusions. FIG. 10 depicts an example way of making such recommendations.

With reference to FIG. 10, this figure depicts a block diagram of a graphical representation of code component level third-party IP remediation in accordance with an illustrative embodiment. Graphical representation 1000 may be generated by a parser, such as parser 408 in FIG. 4 or parser 702 in FIG. 7, using a combination of the processes of FIGS. 4 and 7.

Graphical representation 1000 may be generated, such as in report 710, in addition to or instead of graphs, such as graphs 500 or 600 in FIG. 5 or 6 respectively. In the example depicted in FIG. 10, graphical representation 1000 depicts code component level third-party IP inclusions, license types associated therewith, and some example remediation actions recommended for those inclusions.

Furthermore, graphical representation 1000 may be generated directly or as an enhancement to graphical representation 900 in FIG. 9. Graphical representation 1000 adds remediation action recommendations as a level of detail to graphical representation 900 in FIG. 9.

Legend 1001 correlates a graphical marking with a type of license associated with a third-party IP inclusion in a module of GUI component 1002. Legend 1003 correlates a graphical marking with a type of remediation action recommended for a type of license or a third-party IP inclusion. The specific graphical markings depicted in graphical representation 1000 are only examples and are not limiting on the illustrative embodiments. Any graphical marking suitable for a particular implementation may be used within the scope of the illustrative embodiments. For example, an implementation may depict the various license types, remediation actions, or both by using combinations of different colors, text, icons, graphics, labels, or other indicators in a rendition of graphical representation 1000.

Graphical representation 1000 depicts only some of the remediation action recommendations associated with only some of the license types. For example, module 1006 that may include third-party code is highlighted using a distinct graphical marking to depict a compulsory remediation of that third-party code in module 1006. For example, the third-party code in module 906 may include proprietary code of a specific third-party and may have to be rewritten completely or in part to eliminate that proprietary code.

As another example, modules 1008 and 1010 may include open-source code with a type of public license associated with that open-source code. Such code or license may or may not have to be remedied depending on specific provisions of the license, specific use of the code, or a combination thereof. To depict and distinguish the remediation action recommendation associated with modules 1008 and 1010 from the recommendation associated with module 1006, graphical representation 1000 highlights modules 1008 and 1010 using another distinct graphical marking.

The illustrative embodiments may recommend the same remediation action for modules 1012 and 1014. Graphical representation 1000 highlights modules 1012 and 1014 using the same graphical marking used to depict the remediation action recommendation for modules 1008 and 1010. Graphical representation 1000 highlights module 1016 using a distinct graphical marking to indicate a different remediation action recommendation for that module.

As an example, a portion of module 1020 may be designed specifically to communicate with modules 1008 or 1010. Accordingly, a remediation action corresponding to the remediation action of modules 1008 or 1010 may have to be performed on that portion of module 1020 as well. Therefore, as an example, graphical representation 1000 depicts portion 1022 in module 1020. Graphical representation 1000 recommends a remediation action for portion 1022 by highlighting portion 1022 with the same graphical marking used to depict the remediation action recommendation for modules 1008 and 1010.

A user may find it useful to have the illustrative embodiments display the results of applying the remediation actions according to the recommendations of FIG. 10. FIG. 11 depicts an example way of displaying the results.

With reference to FIG. 11, this figure depicts a block diagram of a graphical representation of the results of code component level third-party IP remediation in accordance with an illustrative embodiment. Graphical representation 1100 may be generated by a parser, such as parser 408 in FIG. 4 or parser 702 in FIG. 7, using a combination of the processes of FIGS. 4 and 7.

Graphical representation 1100 may be generated, such as in report 710, in addition to or instead of graphs, such as graphs 500 or 600 in FIG. 5 or 6 respectively. In the example depicted in FIG. 11, graphical representation 1100 depicts code component level third-party IP inclusions, license types associated therewith, and some example remediation actions performed for remedying those inclusions.

Furthermore, graphical representation 1100 may be generated directly or as an enhancement to graphical representation 900 in FIG. 9 or 1000 in FIG. 10. Graphical representation 1100 adds remediation action results as a level of detail to graphical representation 900 in FIG. 9 or 1000 in FIG. 10.

Legend 1101 correlates a graphical marking with a type of license associated with a third-party IP inclusion in a module of GUI component 1102. Legend 1103 correlates a graphical marking with a result of a remediation action for a type of license or a third-party IP inclusion. The specific graphical markings depicted in graphical representation 1100 are only examples and are not limiting on the illustrative embodiments. Any graphical marking suitable for a particular implementation may be used within the scope of the illustrative embodiments. For example, an implementation may depict the various license types, remediation actions, results, or a combination thereof by using combinations of different colors, text, icons, graphics, labels, or other indicators in a rendition of graphical representation 1100.

Updated legend 1101 graphical representation 1100 informs a user that a specific third-party IP license, such as GPL, are third-party IP acceptable inclusions. Consequently, the license associated with module 1106 can be disregarded and no remediation action need be performed on module 1106.

Graphical representation 1100 further informs a user that performing the remediation actions, as recommended or otherwise, on modules 1108, 1110, 1112, 1114, and 1122 have resulted in an approval from the appropriate approving authority. For example, an IP audit group may approve the code fixes, code changes, or no remediation action, executed with respect to specific code components.

Graphical representation 1100 further informs the user that a third-party license type remains associated with module 1116. Graphical representation 1100 thus informs the user that either a remediation action may not have been executed with respect to that module, or results of the remediation actions on that module may not available. Graphical representation 1100 may display only some of the results of the remediation actions as those actions are performed.

Graphical representation 1100 may be updated to display additional results as more remediation actions are completed. For example, a parser that generates graphical representation 1100 may receive information from a workflow engine about the status of various remediation actions. Thus, graphical representation 1100 may provide a user a work-in-progress view of the remediation.

The particular results depicted in FIG. 11 are only examples and are not limiting on the illustrative embodiments. The illustrative embodiments may be configured to depict completed, incomplete, abandoned, or any other status of a particular remediation action on graphical representation 1100 within the scope of the illustrative embodiments.

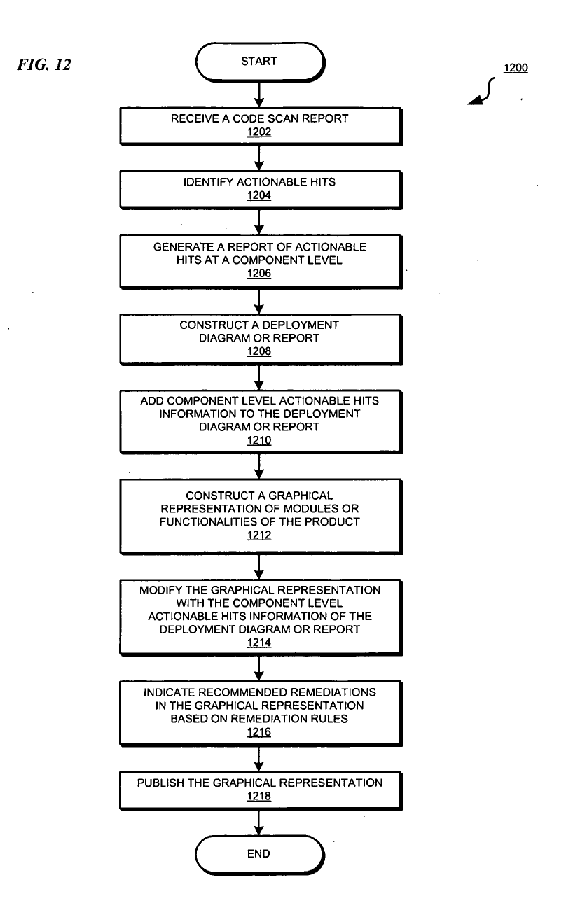

With reference to FIG. 12, this figure depicts a flowchart of a process of graphically representing code component level third-party IP remediation in accordance with an illustrative embodiment. Process 1200 may be implemented using a parser, such as parser 702 in FIG. 7.

Process 1200 begins by receiving a code scan report (step 1202). Process 1200 identifies actionable instances of third-party IP inclusions based on the code scan (step 1204).

Process 1200 generates a report of the actionable instances at a component level (step 1206). Process 1200 may generate the report as a deployment diagram, a component model, or another type of report (step 1208). Process 1200 adds one or more levels of detailed information about actionable instances at the component level to the report of step 1208 (step 1210). An embodiment of process 1200 may end thereafter. Another embodiment of process 1200 may supplement the report of step 1210 with the execution of some or all of the additional steps as described in the remainder of process 1200.

Process 1200 constructs a graphical representation of modules, functionalities, or components of the product being analyzed (step 1212). Process 1200 modifies the graphical representation with information about component level actionable instances, such as from the report of step 1210 (step 1214).

Process 1200 may modify the graphical representation of step 1214 with recommended remediation actions for those actionable instances (step 1216). The recommendations may be based on the result of executing one or more remediation rules.

Process 1200 publishes the graphical representation (step 1218). Process 1200 ends thereafter. Process 1200 may publish the graphical representation by printing a hardcopy on a printer, displaying on a monitor, storing the data associated with the graphical representation on a server's data storage unit, or by any other suitable way.

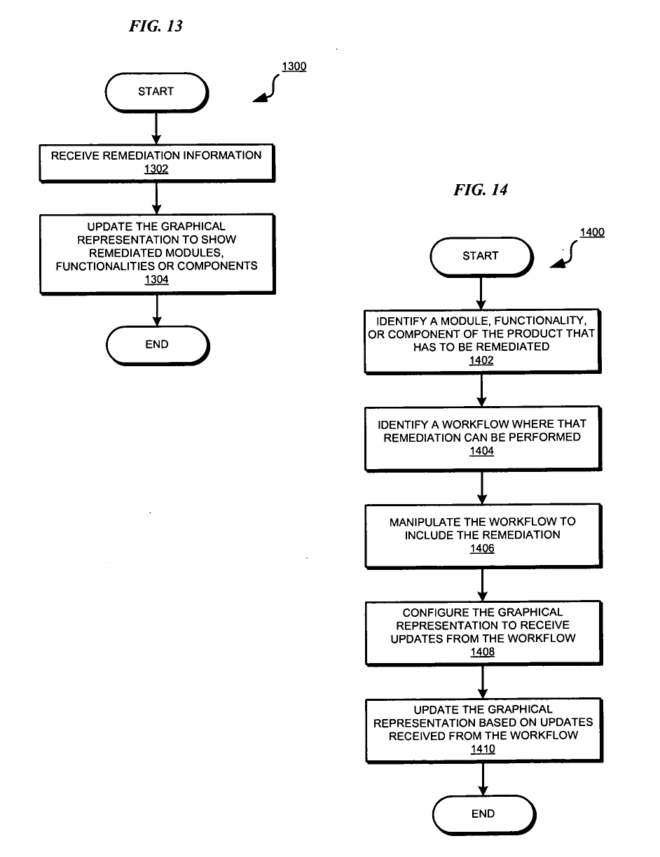

With reference to FIG. 13, this figure depicts a flowchart of a process of modifying a graphical representation of code component level third-party IP remediation in accordance with an illustrative embodiment. Process 1300 may be implemented using a parser, such as parser 702 in FIG. 7.

Process 1300 begins by receiving remediation information, such as from a process or workflow application that is designated to remedy a certain third-party IP inclusion (step 1302). Process 1300 updates a graphical representation, such as the publication of step 1218 in FIG. 12 (step 1302). Process 1300 ends thereafter. The update of step 1302 may show remediated modules, status of a particular remediation effort, omission of a remediation action, or another status of a module or a remediation action associated therewith.

With reference to FIG. 14, this figure depicts a flowchart of a process of interacting with a remediation process for code component level third-party IP remediation in accordance with an illustrative embodiment. Process 1400 may be implemented using a parser, such as parser 702 in FIG. 7.

Process 1400 begins by identifying a module, functionality, or a component that has to be remediated (step 1402). Process 1400 identifies a process, such as a workflow in a workflow application or a workflow in a plan, where the remediation can be performed (step 1404).

Process 1400 manipulates the workflow to include the remediation action (step 1406). For example, the remediation action may be to rewrite a portion of a code component. Process 1400 may insert a re-coding task prior to the next unit testing task in a software development project plan.

Process 1400 configures the graphical representation, such as the publication of step 1218 in FIG. 12, to receive updates from the workflow (step 1408). Process 1400 updates the graphical representation based on the updates received from the workflow (step 1410). Process 1400 ends thereafter. For example, process 1400 may receive an email from a software developer that a remediation action has been completed. Process 1400 may update the status of the remediation action in the graphical representation based on the email notification.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments code component level third-party IP remediation in a software product. Using the illustrative embodiments, a manufacturer can automate the process of analyzing dependencies on third-party IP within the manufacturer's software products.

Additionally, using the illustrative embodiments, the manufacturer may be further able to determine the specific remedial actions that may have to be taken with respect to specific instances of third-party IP in a software product. The remediation action determination can be performed automatically or in conjunction with a manual process.

The illustrative embodiments provide models and graphical representations of components, modules, or functionalities of a product that may include third-party IP. In such graphical representations, the illustrative embodiments further provide several levels of information pertaining to the location, relationships, and implications of the various third-party IP inclusions. For example, the illustrative embodiments highlight the types of licenses and remediation action recommendations that may be associated with particular inclusions, particular modules, or a combination thereof.

The illustrative embodiments thus provide visual clues to a user to better comprehend the nature and consequences of the various third-party IP inclusions. The illustrative embodiments further provide ways to update such graphical representations based on the status of remediation actions received from a workflow.

The illustrative embodiments include remediation rules that facilitate the determination of remediation actions. In certain embodiments, the remediation rules may also automatically trigger the remediation actions.

Furthermore, the illustrative embodiments may cause remediation actions that may result in code change, or coding based software product changes to remediate an instance of a third-party IP. The illustrative embodiments may also cause remediation actions that result in a negotiation process that may leave the instance of the third-party IP intact but change the terms of license for using that instance.

An implementation of the illustrative embodiments may use any knowledge-base that may provide information useful in determining a remediation action. The illustrative embodiments may produce a remediation report, perform remediation actions, or modify workflows for remedying instances of third-party IP in software products. Although the illustrative embodiments have been described with respect to third-party IP in software products, the illustrative embodiments are similarly usable in other types of non-computer software products, such as for remedying third-party's copyright in authored works.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for managing component level intellectual property remediation in a product, the computer implemented method comprising:
identifying an actionable instance of the third-party's intellectual property in a component of the product;
constructing a component model of the product;
associating the actionable instance of the third-party's intellectual property with a component in the component model;
creating graphical representation of the component model;
adding to the graphical representation of the component, information about a type of license associated with the actionable instance; and
publishing the graphical representation.

2. The computer implemented method of claim 1, wherein the actionable instance is identified based on (i) the type of the license associated with the third-party's intellectual property, and (ii) a context of the inclusion.

3. The computer implemented method of claim 1, further comprising:
identifying a remediation action for the actionable instance; and
adding information corresponding to the remediation action to the component in the graphical representation.

4. The computer implemented method of claim 3, further comprising:
identifying a dependency of a second component on the component;
identifying a second remediation action for the second component; and
adding information corresponding to the second remediation action to the second component in the graphical representation.

5. The computer implemented method of claim 3, further comprising:
identifying a workflow where the remediation action can be performed; and
adding the remediation action to the workflow.

6. The computer implemented method of claim 5, further comprising:
receiving a status of the remediation action from the workflow; and
updating the graphical representation such that the status is associated with the component in the graphical representation.

7. The computer implemented method of claim 6, wherein the status corresponds to the remediation action being one of (i) completed and approved, (ii) incomplete, (iii) omitted and acceptable, and (iv) in progress.

8. The computer implemented method of claim 1, wherein adding the information is performed by visually highlighting a part of the graphical representation corresponding to the component.

9. A computer usable program product comprising a computer usable storage medium including computer usable code for managing component level intellectual property remediation in a product, the computer usable code comprising:
computer usable code for identifying an actionable instance of the third-party's intellectual property in a component of the product;
computer usable code for constructing a component model of the product;
computer usable code for associating the actionable instance of the third-party's intellectual property with a component in the component model;
computer usable code for creating graphical representation of the component model;
computer usable code for adding to the graphical representation of the component, information about a type of license associated with the actionable instance; and
computer usable code for publishing the graphical representation.

10. The computer usable program product of claim 9, wherein the actionable instance is identified based on (i) the type of the license associated with the third-party's intellectual property, and (ii) a context of the inclusion.

11. The computer usable program product of claim 9, further comprising:
computer usable code for identifying a remediation action for the actionable instance; and
computer usable code for adding information corresponding to the remediation action to the component in the graphical representation.

12. The computer usable program product of claim 11, further comprising:
computer usable code for identifying a dependency of a second component on the component;
computer usable code for identifying a second remediation action for the second component; and
computer usable code for adding information corresponding to the second remediation action to the second component in the graphical representation.

13. The computer usable program product of claim 11, further comprising:
computer usable code for identifying a workflow where the remediation action can be performed;
computer usable code for adding the remediation action to the workflow;
computer usable code for receiving a status of the remediation action from the workflow; and
computer usable code for updating the graphical representation such that the status is associated with the component in the graphical representation.

14. The computer usable program product of claim 9, wherein adding the information is performed by visually highlighting a part of the graphical representation corresponding to the component.

15. The computer program product of claim 9, wherein the computer usable code is stored in a computer readable storage medium in a data processing system, and wherein the computer usable code is transferred over a network from a remote data processing system.

16. The computer program product of claim 9, wherein the computer usable code is stored in a computer readable storage medium in a server data processing system, and wherein the computer usable code is downloaded over a network to a remote data processing system for use in a computer readable storage medium associated with the remote data processing system.

17. A data processing system for managing component level intellectual property remediation in a product, the data processing system comprising:
a storage device including a storage medium, wherein the storage device stores computer usable program code; and
a processor, wherein the processor executes the computer usable program code, and wherein the computer usable program code comprises:
computer usable code for identifying an actionable instance of the third-party's intellectual property in a component of the product;
computer usable code for constructing a component model of the product;
computer usable code for associating the actionable instance of the third-party's intellectual property with a component in the component model;
computer usable code for creating graphical representation of the component model;
computer usable code for adding to the graphical representation of the component, information about a type of license associated with the actionable instance, wherein adding the information is performed by visually highlighting a part of the graphical representation corresponding to the component; and
computer usable code for publishing the graphical representation.

18. The data processing system of claim 17, wherein the actionable instance is identified based on (i) the type of the license associated with the third-party's intellectual property, and (ii) a context of the inclusion, the data processing system further comprising:
computer usable code for identifying a remediation action for the actionable instance; and
computer usable code for adding information corresponding to the remediation action to the component in the graphical representation.

19. The data processing system of claim 18, further comprising:
computer usable code for identifying a dependency of a second component on the component;
computer usable code for identifying a second remediation action for the second component; and
computer usable code for adding information corresponding to the second remediation action to the second component in the graphical representation, wherein adding the information is performed by visually highlighting a part of the graphical representation corresponding to the second component.

20. The data processing system of claim 18, further comprising:
computer usable code for identifying a workflow where the remediation action can be performed;
computer usable code for adding the remediation action to the workflow;
computer usable code for receiving a status of the remediation action from the workflow; and
computer usable code for updating the graphical representation such that the status is associated with the component in the graphical representation.
